(19) United States
(12) Patent Application Publication
(10) Pub. No.: US 2014/0348474 A1
(43) Pub. Date: Nov. 27, 2014

(54) SUBSTRATE MOUNTING TYPE PHOTOELECTRIC CONVERSION CONNECTOR

(71) Applicants: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP)

(72) Inventor: Masayuki INOUE, Yokkaichi (JP)

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka (JP)

(21) Appl. No.: 14/278,425

(22) Filed: May 15, 2014

(30) Foreign Application Priority Data
May 21, 2013 (JP) 2013-106680

(51) Int. Cl. G02B 6/42

(52) U.S. Cl. CPC G02B 6/4206
USPC 385/93; 385/92

(57) ABSTRACT

A substrate mounting type photoelectric conversion connector capable of reducing stress produced in a portion in which a lead terminal and a substrate are connected to each other is provided. The substrate mounting type photoelectric conversion connector includes an optical unit including a fitting portion to which a mating optical member can be fit, in which at least a portion that includes the fitting portion and serves as a path of optical signals is formed of a light-transmissive material; a photoelectric conversion unit including a photoelectric conversion element that is disposed such that an optical axis coincides with an optical axis of the mating optical member; and a lead terminal that is connected to the photoelectric conversion unit and that electrically connects the photoelectric conversion element to a substrate, the optical unit provided with a substrate connecting portion that is configured connect to the substrate.

This application claims priority to Japanese Patent App. No. JP2013-106680 that was filed on May 21, 2013. The disclosure of the prior application is hereby incorporated by reference herein in its entirety.

### BACKGROUND

JP 2012-137537A describes a substrate mounting type photoelectric conversion connector of this type (hereinafter, referred to as merely a “photoelectric conversion connector” as well). This type of the photoelectric conversion connector is provided with a lead terminal (terminal fitting 24) for transmitting/receiving electric signals after or before being photoelectrically converted to/from a substrate (a circuit formed on the substrate) on which the photoelectric conversion connector is mounted. The photoelectric conversion connector and the substrate are electrically and physically connected by soldering this lead terminal to the substrate.

### SUMMARY

The photoelectric conversion connector described in JP 2012-137537A includes a fitting portion (sleeve 34) to which a mating optical member can be fitted. Force applied to the fitting portion when the mating optical member is fitted thereto is directly transmitted to the entire connector and results in stress produced in the portion in which the lead terminal and the substrate are connected to each other, photoelectric conversion connectors as described in JP 2012-137537A are problematic; the reliability of the electric connection between the lead terminal and the substrate deteriorates due to the force produced when the mating optical member is fitted thereto.

It is an object to provide a substrate mounting type photoelectric conversion connector capable of reducing stress produced in the portion in which a lead terminal and a substrate are connected to each other.

To solve the foregoing problems, a substrate mounting type photoelectric conversion connector is provided including an optical unit including a fitting portion to which a mating optical member can be fit, in which at least a portion that includes the fitting portion and serves as a path of optical signals is formed of a light-transmissive material; a photoelectric conversion unit including a photoelectric conversion element that is disposed such that an optical axis thereof coincides with an optical axis of the mating optical member; and a lead terminal that is connected to the photoelectric conversion unit and that is configured to electrically connect the photoelectric conversion element to a substrate, wherein the optical unit is provided with a substrate connecting portion that is configured to be connected to the substrate. Here, “substrate mounting type photoelectric conversion connector” may refer to a photoelectric conversion connector (or photoelectric conversion assembly) that is mounted to a substrate or one that is configured to be mounted to a substrate but not yet mounted to the substrate.

It is preferable that the substrate connecting portion is constituted of a metal material.

It is preferable that the optical unit has a connecting metal member that is integrally formed of the metal material and includes the substrate connecting portion and a shield portion facing at least a portion of surfaces constituting the photoelectric conversion unit.

It is preferable that an opening is formed in the shield portion of the connecting metal member at the portion serving as the path of optical signals.

It is preferable that a shield member is provided so as to face at least a portion of the surfaces constituting the photoelectric conversion unit other than the surface that the shield portion in the connecting metal member faces.

It is preferable that the optical unit and the photoelectric conversion unit are abutted against and integrated with each other such that a space is formed thereinside and the photoelectric conversion element is located in that space.

It is preferable that the optical unit includes a lens portion through which light emitted from the mating optical member or light emitted from the photoelectric conversion element passes and the lens portion is located in that space.

Since the substrate mounting type photoelectric conversion connector has a configuration in which not only the lead terminal provided in the photoelectric conversion unit but also the substrate connecting portion provided in the optical unit are connected to the substrate, almost all the force produced when the mating optical member is fitted to the fitting portion acts on the portion in which the substrate connecting portion and the substrate are connected to each other. That is, it is possible to reduce stress produced in the portion in which the lead terminal and the substrate are connected to each other, and therefore, reliability of the connection at the portion is enhanced.

If the substrate connecting portion is constituted of a metal material, it is possible to simultaneously connect the substrate to the lead terminal, and the substrate to the substrate connecting portion by soldering or the like.

If a configuration is adopted in which a connecting metal member including a shield portion that is arranged to face at least a portion of the photoelectric conversion unit is provided, the electromagnetic shield effect with respect to the photoelectric conversion unit is enhanced. The shield portion is provided in the connecting metal member together with the substrate connecting portion. That is, the connecting metal member exhibits an effect of reducing the above-described stress produced in the portion in which the lead terminal and the substrate are connected to each other, and an effect of enhancing the shield effect.

If a configuration is adopted in which an opening is formed in the shield portion in the connecting metal member so as not to cut off the path of optical signals, a portion covering the photoelectric conversion unit can be enlarged, and the shield effect is enhanced.

If a configuration is adopted in which the shield member is provided so as to face at least a portion of surfaces other than the surface that the shield portion in the photoelectric conversion unit faces, the shield effect with respect to the photoelectric conversion unit is further enhanced. From another viewpoint, the shield portion in the connecting metal member complementarily covers a portion that cannot be covered with the shield member.

If a configuration is adopted in which the optical unit and the pohotoelectric conversion unit are integrated such that a space is formed thereinside and the photoelectric conversion element and a lens portion are disposed in the space, the occurrence of noise caused by dust attaching to the photoelectric conversion element (a light receiving portion or a light emitting portion thereof) and the lens portion is suppressed.

### BRIEF DESCRIPTION OF THE DRAWINGS

FIG. 1 is an outside view of a substrate mounting type photoelectric conversion connector according to an embodiment.

FIG. 2 is a cross-sectional view (taken along A-A line shown in FIG. 1) of the substrate mounting type photoelectric conversion connector according to an embodiment (in a state of being mounted on an outer substrate).

FIG. 3 is an outside view of an assembly obtained by integrating an optical unit, a photoelectric conversion unit, and lead terminals.

### DETAILED DESCRIPTION OF THE EMBODIMENTS

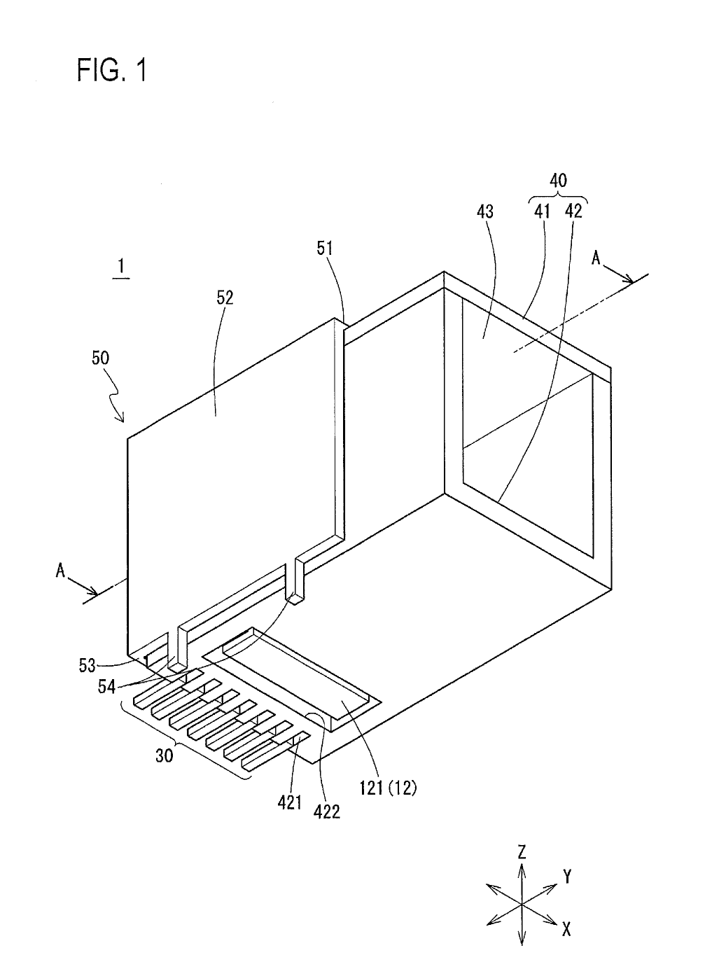

Hereinafter, embodiments will be described in detail with reference to the drawings. It should be noted that in the following description, “width direction” refers to a short-length direction of the connector, that is, the X-axis direction in FIG. 1, “front-to-back direction” (direction of optical axis C; the front is on the side of a photoelectric conversion element 21 and the back is on the side of a fitting portion 112) refers to a longitudinal direction of the connector, that is, the Y-axis direction in FIG. 1, and “vertical direction” refers to a direction that is perpendicular to the width direction and the optical axis direction, that is, the Z-axis direction in FIG. 1. In addition, “plane direction” refers to a direction parallel to the surface (mounting surface) of an outer substrate 80.

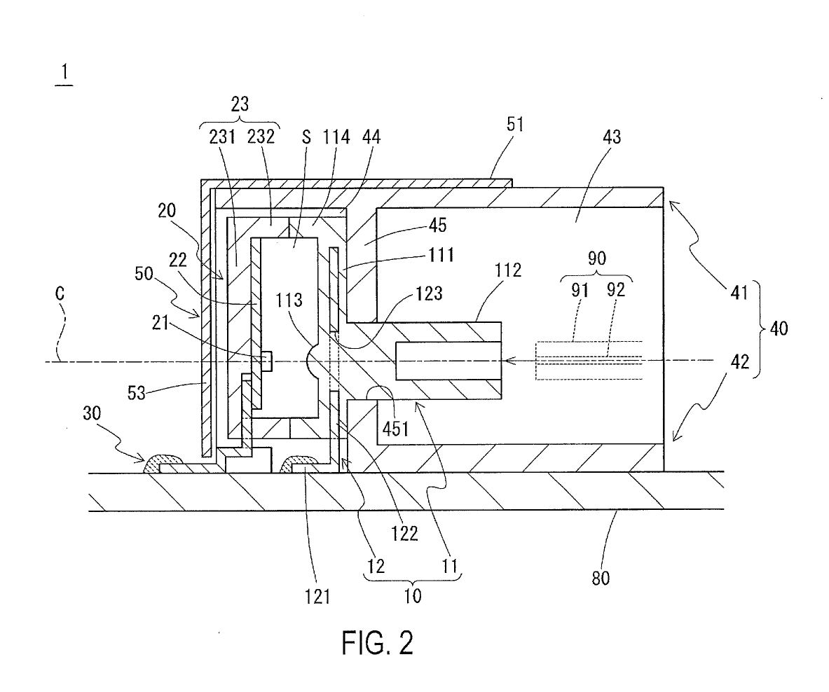

A substrate mounting type photoelectric conversion connector 1 according to an embodiment of the present invention shown in FIGS. 1 and 2 is mounted on the outer substrate 80 (corresponding to the substrate of the present invention; see FIG. 2), converts optical signals to electric signals and transmits the electric signals to a circuit provided on the outer substrate 80. The photoelectric conversion connector 1 includes an optical unit 10, a photoelectric conversion unit 20, a lead terminal 30, a housing 40, and a shield member 50. Hereinafter, the respective configurations will be described in detail.

The optical unit 10 includes a fitting portion 112 (also referred to as a “sleeve” or the like) to which a mating optical member 90 is fitted. In this embodiment, portions other than a connecting metal member 12 described below are integrally formed of a light-transmissive material. However, portions other than the portion serving as the path of optical signals may also be formed of a material other than a light-transmissive material. A portion 11 formed of a light-transmissive material is a generally tray-shaped portion including a body portion 111, the fitting portion 112, a lens portion 113 and a wall 114.

The body portion 111 is a plate-shaped portion located along a plane perpendicular to the front-to-back direction. The fitting portion 112 is a tubular portion projecting from the center of the surface on one side of the body portion 111 perpendicular to the front-to-back direction (direction of optical axis C). The central axis of the “tube” in this fitting portion 112 coincides with the optical axis C of the optical members. The fitting portion 112 is formed such that the mating optical member 90 (for example, a ferrule 91 to which an optical fiber 92 is fixed) indicated by dotted lines in FIG. 2 can be fitted thereto. When the mating optical member 90 is fitted to the fitting portion 112, the axis of the optical fiber 92 coincides with the optical axis C.

The lens portion 113 projects from the center of the surface on the other side of the body portion 111 perpendicular to the front-to-back direction. This lens portion 113 is a convergent lens whose optical axis C coincides with the central axis of the “tube” in the fitting portion 112 described above. Light emitted from the optical fiber 92 in the mating optical member 92 that is fitted to the fitting portion 112 passes through the portion 11 formed of a light-transmissive material as divergent light, and is converged by the lens portion 113. The lens portion 113 is shaped and located such that the converged light is focused on a light receiving portion in the photoelectric conversion element 21.

The wall 114 projects from the outer edge of the surface on the other side of the body portion 111 perpendicular to the front-to-back direction. The projection height thereof is larger than that of the lens portion 113 (distance from the surface on the other side of the body portion 111 to the front end of the lens portion 113).

The connecting metal member 12 is fixed to the portion 11 formed of a light-transmissive material, having such a configuration. In this embodiment, a portion of the connecting metal member 12 (shield portion 122 described below) is embedded in the above-described body portion 111 by insert molding and the connecting metal member 12 and the body portion 111 are integrated with each other. The connecting metal member 12 is formed so as to have a cross-section with substantially an “L” shape and includes a substrate connecting portion 121 and the shield portion 122.

The substrate connecting portion 121 is formed at the lower end of the connecting metal member 12 and extends along the plane direction. The substrate connecting portion 121 is exposed through an opening 422 formed in a housing 40 described below and is located at substantially the same height as the lower end surface of the housing 40. This substrate connecting portion 121 is physically connected to the outer substrate 80 by soldering or the like and is electrically connected to a circuit formed on the outer substrate 80. The substrate connecting portion 121 is connected to ground via this circuit formed on the outer substrate 80.

The shield portion 122 is located along a plane perpendicular to the front-to-back direction and faces at least a portion of the photoelectric conversion unit 20 in the front-to-back direction. An opening 123 is formed in the shield portion 122 embedded in the body portion 111 at the position where it intersects with the optical axis C. The opening 123 is formed in such a size (shape) that the path of the divergent light emitted from the optical fiber 92 in the mating optical member 90 is not cut off. However, if the opening 123 is too large, the electromagnetic shield effect by the shield portion 122 is deteriorated, and therefore, it is preferable that the opening 123 is as small as possible. Since all the divergent light emitted from the optical fiber 92 in the mating optical member 90 is set so as to be incident on the lens portion 113 in the portion 11 formed of a light-transmissive material in the optical unit 10, if the opening 123 and the lens portion 113 have substantially the same shape when viewed in the front-to-back direction (that is, the shape of the outer circumferential edge of the lens portion 113 and the shape of the outer circumferential edge of the opening 123 substantially coincide with each other), the shield portion 122 does not cut off the light and the shield effect does not deteriorate significantly.

The photoelectric conversion unit 20 includes a photoelectric conversion element 21 (light receiving element) that converts optical signals emitted from the optical fiber 92 to electric signals. The photoelectric conversion element 21 is mounted on an inner substrate 22 on which a circuit or the like for transmitting the converted electric signals to the outer substrate 80 is formed. The optical axis (the center of the light receiving element) of the photoelectric conversion element 21 coincides with the optical axis of the optical fiber 92 in the mating optical member 90. Specifically, the light that is emitted from the optical fiber 92 in the mating optical member 90 and is converged by the lens portion 113 is set so as to be focused on the center of the light receiving portion of the photoelectric conversion element 21. The photoelectric conversion unit 20 includes this photoelectric conversion element 21, the inner (internal) substrate 22 on which this photoelectric conversion element 21 is mounted, and a supporting member 23, which is specifically described below.

A plurality of the lead terminals 30 are connected by soldering or the like to the circuit that is formed on the inner substrate 22 and transmits electric signals to the outer (external) substrate 80. A portion of the lead terminal 30 is led out to the exterior of the housing 40. Specifically, a portion extending along the plane direction is formed at an end portion of the lead terminal 30 on the opposite side from the side on which the lead terminal 30 is connected to the inner substrate 22, and that portion is led out to the exterior of the housing 40. This portion of the lead terminal 30 extending along the plane direction is located at the same position in the vertical direction as the above-described substrate connecting portion 121 (the portion of the connecting metal member 12 extending along the plane direction).

The inner substrate 22 on which the photoelectric conversion element 21 is mounted, and the lead terminals 30 are fixed to the supporting member 23. The supporting member 23 is formed in substantially the same shape (tray shape) as that of a portion of the portion 11 formed of a light-transmissive material in the optical unit described above, and includes a body portion 231 and a wall 232. The body portion 231 is a plate-shaped portion perpendicular to the front-to-back direction, and the wall 232 projects from the outer edge of the body portion 231 to the side of the optical unit 10. The inner substrate 22 on which the photoelectric conversion element 21 is mounted is disposed along the surface (inner bottom surface) of the body portion 231 in the supporting member 23 on the side of the optical unit 10. The lead terminals 30 pass through the wall 232 on the lower side of the supporting member 23 and are led out to the lower side of the housing 40. That is, by press-fitting the lead terminals 30 connected to the inner substrate 22 to a through hole formed in the supporting member 23, the inner substrate 22 on which the photoelectric conversion element 21 is mounted, and the lead terminals 30 are fixed to the supporting member 23. In other words, an assembly is obtained in which the lead terminals 30 are connected to the photoelectric conversion unit 20 including the photoelectric conversion element 21, the inner substrate 22 on which this photoelectric conversion element 21 is mounted, and the supporting member 23.

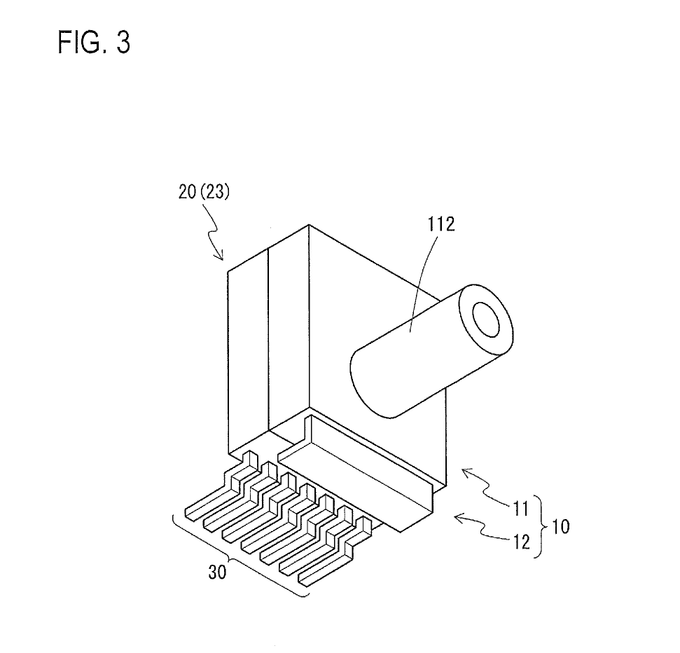

As shown in FIG. 3, the photoelectric conversion unit 20 (the assembly including the photoelectric conversion unit 20 and the lead terminals 30) is integrated with the above-described optical unit 10. Specifically, the photoelectric conversion unit 20 and the optical unit 10 are integrated such that the wall 232 projecting to the side of the optical unit 10 in the supporting member 23 included in the photoelectric conversion unit 20 and the wall 114 projecting to the side of the photoelectric conversion unit 20 in the portion 11 formed of a light-transmissive material included in the optical unit 10 are abutted against each other. This integrating method is not limited to any specific method. Any method can be adopted as long as the photoelectric conversion element 21 and the lens portion 113 are positioned so as to have a positional relation as described above and are integrated with each other.

Since the tray-shaped supporting member 23 and a portion of the portion 11 formed of a light-transmissive material in the optical unit 10 are thus abutted against each other, a space S is formed inside the walls 114 and 232. The photoelectric conversion element 21, the inner substrate 22 on which the photoelectric conversion element 21 is mounted, and the lens portion 113 are disposed inside the space S surrounded by these walls 114 and 232.

The housing 40 is a member including an upper housing 41 and a lower housing 42, in which a connector engaging portion 43 and a unit housing portion 44 are formed. An optical connector (not shown) to which the mating optical member 90 is fixed is engaged with the connector engaging portion 43. The optical unit 10 and the photoelectric conversion unit 20 (except for the fitting portion 112) that are integrated with each other are housed in the unit housing portion 44. The connector engaging portion 43 and the unit housing portion 44 are partitioned by a partition plate 45, and the tubular fitting portion 112 is inserted into a through hole 451 formed in this partition plate 45. The through hole 451 is formed by conjoining a semicircular portion that is formed in a portion included in the partition plate 45 in the upper housing 41 and a semicircular portion that is formed in a portion included in the partition plate 45 in the lower housing 42. Grooves 421 into which the lead terminals 30 arranged in the width direction with predetermined gaps therebetween are inserted are formed on the front side of the lower surface of the housing 40 (lower housing 42). In addition, an opening 422 for exposing the substrate connecting portion 121 is formed on the backward side of the positions where the grooves 421 are formed on the lower surface of the housing 40 (lower housing 42). After the assembly obtained by integrating the optical unit 10, photoelectric conversion unit 20, and the lead terminals 30 is assembled to the lower housing 42 (each member is assembled so as to be located at a predetermined position), the assembly obtained by integrating the optical unit 10, photoelectric conversion unit 20, and the lead terminals 30 is integrated with the housing 40 by connecting the upper housing 41 to the lower housing 42. It should be noted that the method for connecting the upper housing 41 and the lower housing 42 is not limited to any specific method.

The shield member 50 is a metal member that exhibits the electromagnetic shield effect with respect to the photoelectric conversion unit 20 and is attached to the housing 40 so as to cover the photoelectric conversion unit 20. The shield member 50 includes a portion 51 facing the upper surface of the photoelectric conversion unit 20, portions 52 facing side surfaces thereof in the width direction, and a portion 53 facing the front surface thereof. As described above, the shield portion 122 of the connecting metal member 12 is provided so as to face the back surface of the photoelectric conversion unit 20, and therefore, surroundings of the photoelectric conversion unit 20 other than the lower side are covered with the shield member 50 (shield portion 122).

The shield member 50 is provided with connecting projections 54 projecting downward from the lower edge thereof. The connecting projections 54 are physically connected to the outer substrate 80 by soldering or the like, and are electrically connected to a circuit formed on the outer substrate 80. The shield member 50 is connected to ground via this circuit formed on the outer substrate 80.

The photoelectric conversion connector 1 with such a configuration is installed at a predetermined position on the outer substrate 80, and the lead terminals 30 and the substrate connecting portion 121 are physically and electrically connected to the outer substrate 80. Although the connecting method is not limited to a specific method, it is preferable that the photoelectric conversion connector 1 is connected to outer substrate 80 by reflow soldering.

With the substrate mounting type photoelectric conversion connector 1 according to this embodiment described above, the following effect is exhibited.

Because the photoelectric conversion connector 1 according to this embodiment has a configuration in which not only the lead terminals 30 provided in the photoelectric conversion unit 20 but also the substrate connecting portion 121 provided in the optical unit 10 are connected to the substrate, almost all the force produced when the mating optical member 90 is fitted to the fitting portion 112 acts on the portion in which the substrate connecting portion 121 and the substrate are connected to each other. That is; it is possible to reduce stress produced in the portion in which the lead terminals 30 and the substrate are electrically connected to each other, and therefore, reliability of the connection at the portion is enhanced.

Because the photoelectric conversion connector 1 has a configuration including the connecting metal member 12 obtained by integrally forming the substrate connecting portion 121 and the shield portion 122, the electromagnetic shield effect with respect to the photoelectric conversion unit 20 is enhanced. That is, the connecting metal member 12 exhibits the effect of reducing stress produced in the portion in which the lead terminals 30 and the substrate are connected to each other, and the effect of enhancing the shield effect. Because the substrate connecting portion 121 integrally formed with this shield portion 122 is also constituted of a metal material, it is possible to simultaneously connect the substrate to the lead terminals 30, and the substrate to the substrate connecting portion 121 by soldering or the like. In particular, when reflow soldering is used, they are easily connected to each other.

Moreover, the opening 123 is formed in the shield portion 122 in the connecting metal member 12 such that it does not cut off the path of optical signals. That is, the path is secured by the opening 123, and a portion covering the photoelectric conversion unit 20 (a portion facing the back surface of the photoelectric conversion unit 20) is enlarged. Therefore, the shield effect of the shield portion 122 is high. In this embodiment, a configuration in which the shield member 50 is provided so as to face the surfaces (upper surface, side surfaces in the width direction, and front surface) other than the surface that the shield portion 122 in the photoelectric conversion unit 20 faces, and therefore, the excellent shield effect with respect to the photoelectric conversion unit 20 is exhibited. From another viewpoint, the shield portion 122 in the connecting metal member 12 complementarily covers a portion that cannot be covered with the shield member 50.

In addition, the photoelectric conversion element 21, the lens portion 113 and the like are disposed inside the space S that is formed by integrating the optical unit 10 and the photoelectric conversion unit 20, and is surrounded by the walls 114 and 232. Therefore, the occurrence of noise caused by dust attaching to the photoelectric conversion element 21 (a light receiving portion or a light emitting portion thereof) and the lens portion 113 is suppressed.

While the embodiment of the present invention has been described in detail, the present invention is not limited to the above-described embodiment, and various modifications can be made without departing from the concept of the present invention.

Although it has been stated that the photoelectric conversion connector 1 according to the above-described embodiment converts optical signals emitted from the optical fiber 92 in the mating optical member 90 to electric signals with the photoelectric conversion element 21 (light receiving element), and transmits the electric signals to the outer substrate 80, the photoelectric conversion connector 1 may be a connector that performs the inverse conversion. That is, the photoelectric conversion connector 1 may convert electric signals transmitted from the outer substrate 80 with the photoelectric conversion element 21 (light emitting element) to optical signals, and the optical signals may be emitted toward the optical fiber 92 in the mating optical member 90. Moreover, the photoelectric conversion connector 1 may have both a function of converting optical signals emitted from the optical fiber 92 to electric signals and transmitting the electric signals to the outer substrate 80, and a function of converting electric signals of the outer substrate 80 to optical signals and transmitting the optical signals to the optical fiber 92.

Moreover, although it has been stated that in the photoelectric conversion connector 1 according to the above-described embodiment, the substrate connecting portion 121 is formed in the connecting metal member 12 that is fixed to the portion 11 formed of a light-transmissive material, a configuration in which the substrate connecting portion 121 is formed in the portion 11 formed of a light-transmissive material may be adopted. A configuration in which a projection that projects from the lower surface of the body portion 111 is provided and the projection is press-fitted to a hole or a recess that is formed in the outer substrate 80 is given as an example of such a configuration. Even when such a configuration is adopted, almost all the force produced when the mating optical member 90 is fitted to the fitting portion 112 acts on the portion in which the projection serving as the substrate connecting portion 121 and the outer substrate 80 are connected to each other, and therefore, it is possible to reduce stress produced in the portion in which the lead terminals 30 and the outer substrate 80 are connected to each other.

What is claimed is:

1. A substrate mounting type photoelectric conversion connector comprising:
an optical unit including a fitting portion configured to fit a mating optical member, in which at least a portion that includes the fitting portion and serves as a path of optical signals is formed of a light-transmissive material;
a photoelectric conversion unit including a photoelectric conversion element that is disposed such that an optical axis thereof coincides with an optical axis of the mating optical member; and
a lead terminal that is connected to the photoelectric conversion unit and that is configured to electrically connect the photoelectric conversion element to a substrate,
wherein the optical unit is provided with a substrate connecting portion that is configured to be connected to the substrate.

2. The substrate mounting type photoelectric conversion connector according to claim 1, wherein the substrate connecting portion is constituted of a metal material.

3. The substrate mounting type photoelectric conversion connector according to claim 2, wherein the optical unit has a connecting metal member that is integrally formed of the metal material and includes the substrate connecting portion and a shield portion facing at least a portion of surfaces constituting the photoelectric conversion unit.

4. The substrate mounting type photoelectric conversion connector according to claim 3, wherein an opening is formed in the shield portion of the connecting metal member at the portion serving as the path of optical signals.

5. The substrate mounting type photoelectric conversion connector according to claim 3, wherein a shield member is provided so as to face at least a portion of the surfaces constituting the photoelectric conversion unit other than the surface that the shield portion in the connecting metal member faces.

6. The substrate mounting type photoelectric conversion connector according to claim 1, wherein the optical unit and the photoelectric conversion unit are abutted against and integrated with each other such that a space is formed thereinside and the photoelectric conversion element is located in that space.

7. The substrate mounting type photoelectric conversion connector according to claim 6, wherein the optical unit includes a lens portion through which light emitted from the mating optical member or light emitted from the photoelectric conversion element passes and the lens portion is located in that space.

8. The substrate mounting type photoelectric conversion connector according to claim 4, wherein a shield member is provided so as to face at least a portion of the surfaces constituting the photoelectric conversion unit other than the surface that the shield portion in the connecting metal member faces.

9. The substrate mounting type photoelectric conversion connector according to claim 2, wherein the optical unit and the photoelectric conversion unit are abutted against and integrated with each other such that a space is formed thereinside and the photoelectric conversion element is located in that space.

10. The substrate mounting type photoelectric conversion connector according to claim 3, wherein the optical unit and the photoelectric conversion unit are abutted against and integrated with each other such that a space is formed thereinside and the photoelectric conversion element is located in that space.

11. The substrate mounting type photoelectric conversion connector according to claim 4, wherein the optical unit and the photoelectric conversion unit are abutted against and integrated with each other such that a space is formed thereinside and the photoelectric conversion element is located in that space.

12. The substrate mounting type photoelectric conversion connector according to claim 5, wherein the optical unit and the photoelectric conversion unit are abutted against and integrated with each other such that a space is formed thereinside and the photoelectric conversion element is located in that space.

13. The substrate mounting type photoelectric conversion connector according to claim 8, wherein the optical unit and the photoelectric conversion unit are abutted against and integrated with each other such that a space is formed thereinside and the photoelectric conversion element is located in that space.

14. The substrate mounting type photoelectric conversion connector according to claim 9, wherein the optical unit includes a lens portion through which light emitted from the mating optical member or light emitted from the photoelectric conversion element passes and the lens portion is located in that space.

15. The substrate mounting type photoelectric conversion connector according to claim 10, wherein the optical unit includes a lens portion through which light emitted from the mating optical member or light emitted from the photoelectric conversion element passes and the lens portion is located in that space.

16. The substrate mounting type photoelectric conversion connector according to claim 11, wherein the optical unit includes a lens portion through which light emitted from the mating optical member or light emitted from the photoelectric conversion element passes and the lens portion is located in that space.

17. The substrate mounting type photoelectric conversion connector according to claim 12, wherein the optical unit includes a lens portion through which light emitted from the mating optical member or light emitted from the photoelectric conversion element passes and the lens portion is located in that space.

18. The substrate mounting type photoelectric conversion connector according to claim 13, wherein the optical unit includes a lens portion through which light emitted from the mating optical member or light emitted from the photoelectric conversion element passes and the lens portion is located in that space.

19. A substrate mounting type photoelectric conversion connector comprising:
an optical unit including
a fitting portion configured to fit a mating optical member, and
at least a portion of the optical unit that includes the fitting portion and serves as a path of optical signals is formed of a light-transmissive material;
a photoelectric conversion unit including
a photoelectric conversion element that is disposed such that an optical axis of the photoelectric conversion element coincides with an optical axis of the mating optical member; and
a lead terminal (i) that is connected to the photoelectric conversion unit and (ii) that is configured to electrically connect the photoelectric conversion element to a substrate,
wherein the optical unit is provided with a substrate connecting portion that is configured to be connected to the substrate.
